(19) United States
(12) Patent Application Publication
(10) Pub. No.: US 2002/0081179 A1
(43) Pub. Date: Jun. 27, 2002

(54) Smart card of a terminal, a terminal using a smart card, and an improved method for identifying a user by means of a smart card

(76) Inventor: Jari Vallstrom, Oulu (FI)

Correspondence Address: PERMAN & GREEN, 425 POST ROAD, FAIRFIELD, CT, 06430, US

(21) Appl. No.: 10/021,958

(22) Filed: Dec. 14, 2001

(30) Foreign Application Priority Data
Dec. 21, 2000 (FI) 20002813

(51) Int. Cl. B65F 9/00

(52) U.S. Cl. 414/333

(57) ABSTRACT

The invention relates to a SIM card (405) to be inserted in a terminal (400) of a communications network, comprising means for storing data (11a, 11b, 11c) required in the identification of at least two users and means for carrying out user identification. The invention also relates to a cellular terminal utilizing the said SIM card. The terminal can be used by several users with their own identification codes without changing the SIM card in the terminal.

The invention relates to a SIM card to be inserted in a terminal of a communications network. The invention further relates to a terminal of a communications network, which terminal is arranged so as to perform user identification when the terminal is activated. Furthermore, the invention relates to a method for identifying on the basis of a personal identification code an individual user of a terminal on a SIM card inserted in a terminal of a communications network.

Various cellular systems apply different methods for identifying the user of a terminal. We might say that the lowest-level identification is a procedure in which it is verified that a user is entitled to use a cellular terminal. Such a verification is realized e.g. using a so-called PIN code (or Personal Identification Number). A PIN code is a multiple-digit code which, when input to an apparatus correctly, allows the user to use the terminal in question. For example, cellular phones of various systems require a PIN code of a few digits in order to grant access to the telephone functionality of a terminal. Only a call made to an emergency number can be made without giving the PIN code. In a cellular phone, such as a GSM (Global System for Mobile communications) cellphone, this identification procedure is included in a separate SIM card (Subscriber Identity Module) which can be inserted in the terminal. Usually each cellular terminal user has got a personal SIM card of his own which he inserts in the terminal he wants to use. As the user enters his PIN code on the terminal the processor in the SIM card matches the PIN code entered against the PIN code associated with the user in the terminal's memory. If this identification procedure yields a positive result the user is granted access to the rest of the functions of the apparatus. Solutions are also known in which at least two separate SIM cards, which may have different PIN codes, can be inserted in a terminal of cellular network.

A SIM card may further include other user-specific information which may allow the user to operate in the cellular network or contribute to it. Such information could include, among other things, various public or secret encryption keys used in the encryption of data transfers, and procedures used in user authentication.

Moreover, there are cellular systems in which it may be at least assumed that several different users have to share the same terminals. Such systems are used by the different authorities like the police, fire brigade and other rescue authorities.

Current systems are usually based on analog technology, are weakly encrypted and incompatible with each other. A common transnational time-division digital cellular telephone system called TETRA (Terrestrial Trunked Radio) is currently being developed for the different authorities. The standardization work on the system is being done by the European Telecommunications Standards Institute (ETSI). The TETRA network shall be easy to use and at the same time it shall have good data security with strong encryption properties. In principle, the authorities in different countries can be connected to one and the same TETRA network. The PIN codes and other possibly needed secret passwords used in identification must not be allowed to spread outside the user community.

A problem with such shared use of terminals is, however, that the users must memorize several different identification codes because they often will not know which terminal they will be given to use in the next shift. Therefore, the identification information and the various passwords are attached using non-allowed methods to the terminal so that, when necessary, the terminal can be activated quickly. For example, a PIN code known to the apparatus may be written on the back of the apparatus either on the casing of the apparatus or on a note glued onto the apparatus. Moreover, a user may store the identification data of several terminals on a separate note. This way, the identification data associated with the use of a terminal may fall in the wrong hands, endangering the security and secrecy of the network used by the authorities. Because of the possibility of leaks of information, some systems recycle the PIN codes and other passwords more quickly than usual. This, however, may lead more likely than before to the users writing down the passwords on pieces of paper, which is naturally undesirable.

An object of the present invention is to provide an apparatus, method and arrangement for ensuring both the security of operation and easiness of activation of a terminal in a multi-user environment.

The objects of the invention are achieved by a SIM card insertable in a cellular terminal, in connection of which SIM card it is stored user-specific identification information for each possible user.

A SIM card according to the invention is characterized in that the SIM card comprises means for storing data used in the identification of at least two users and means for carrying out user identification using the said data.

A terminal according to the invention is characterized in that the terminal's means for identifying a user comprise a SIM card arranged so as to identify at least two or more users entitled to use the terminal on the basis of at least one user-specific identification code.

A method according to the invention is characterized in that user identification is carried out by matching the identification code given by the user against identification codes stored on the SIM card for different users, and if the identification code given by the user of the terminal is among the said identification codes, the activation of the terminal is allowed.

Advantageous embodiments of the invention are presented in the dependent claims.

The basic idea of the invention is as follows: A SIM card is inserted in a cellular terminal, which SIM card stores several PIN codes for different users. Thus each user only needs to know his own PIN code independent of the terminal he is given. In addition to the PIN identification some other additional identification/password may be required of the user in order to grant him access to the functions of the terminal. In addition to separate PIN codes the SIM card may store various other user-specific data used in the encryption and communication. Such user-specific data can be used only by the identified user in question.

An advantage of the invention is that only one SIM card has to be inserted in the shared cellular terminals so that each user may use the said SIM card with his personal PIN code/additional identifier.

Another advantage of the invention is that the activation of a shared terminal becomes easier since it can be activated using the identification codes known to each user.

A further advantage of the invention is that the SIM card may store other user-specific data for each user, which data may be utilized during a communications connection/session.

The invention is below described in detail. Reference is made in the description to the accompanying drawings in which

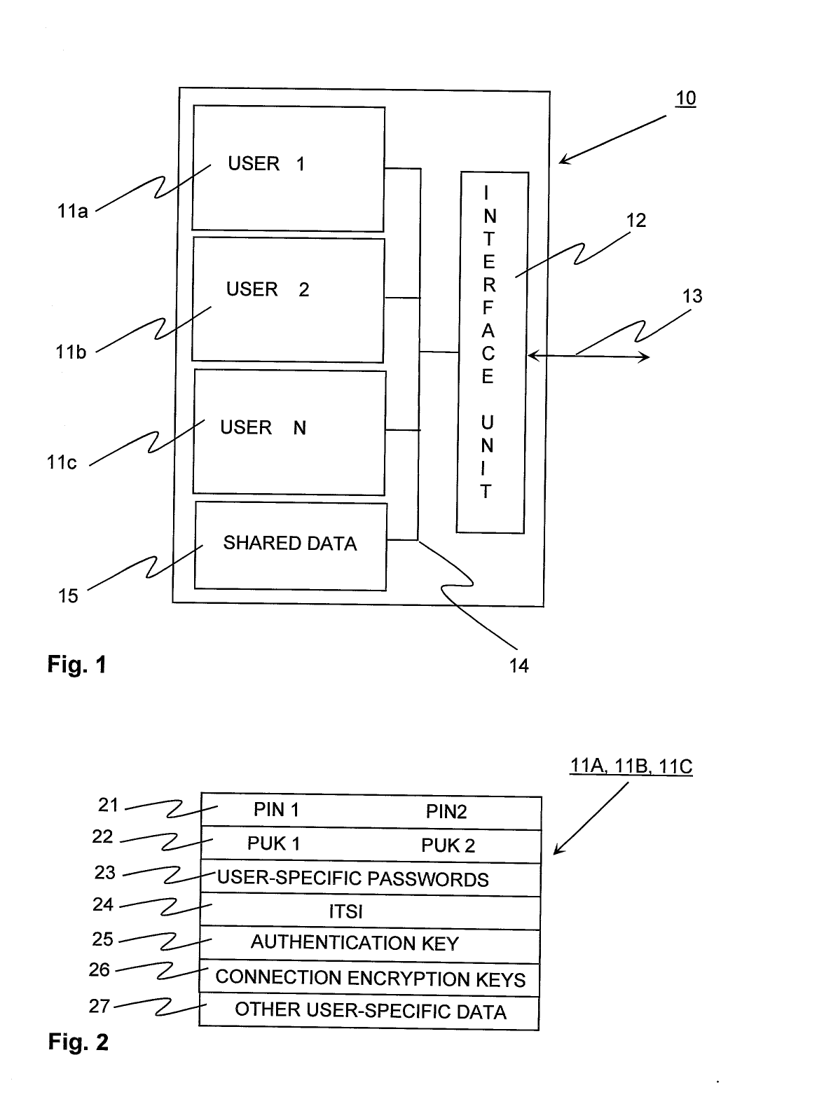

FIG. 1 shows by way of example main parts of a SIM card according to the invention,

FIG. 2 shows by way of example a user-specific data structure on a SIM card,

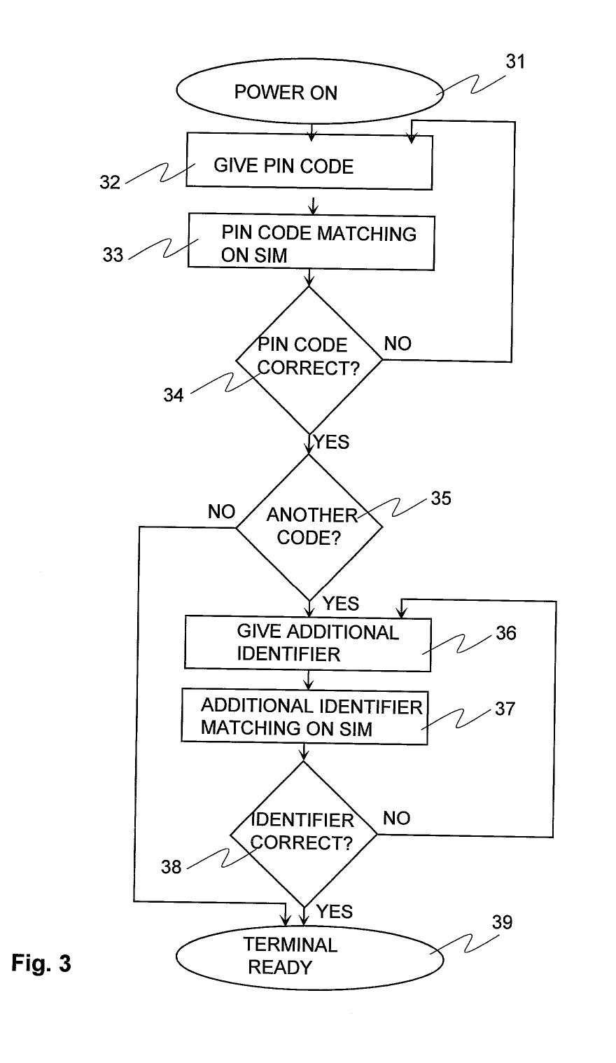

FIG. 3 shows by way of example a flow diagram of a user identification procedure facilitating a SIM card according to the invention, and

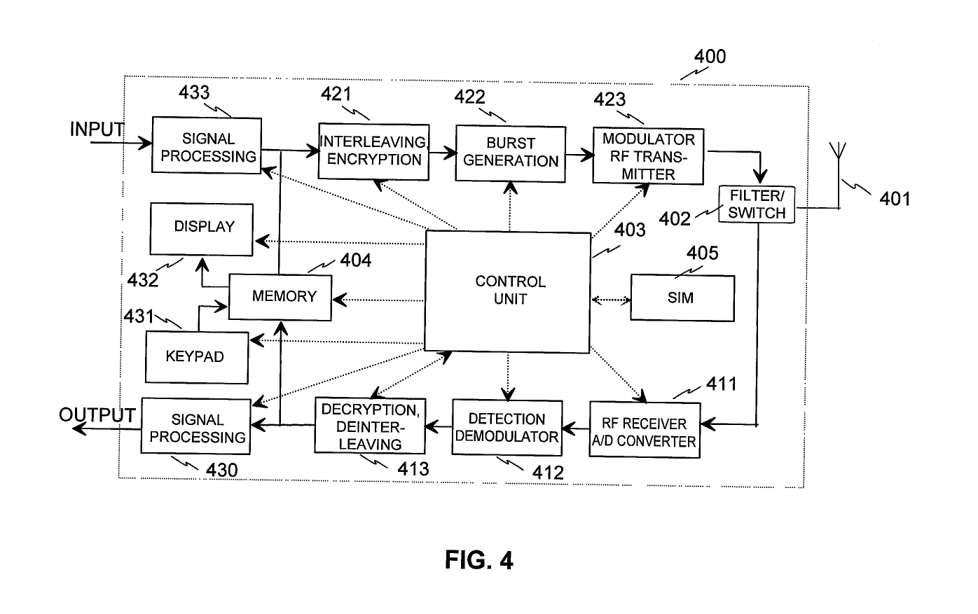

FIG. 4 shows by way of example a cellular terminal utilizing a SIM card according to the invention.

FIG. 1 shows by way of example main parts according to the invention in a SIM card 10 insertable in a terminal of a cellular network. On the SIM card according to the invention there is reserved user-specific data storage space for several users 1, 2, . . . N. Each user-specific record 11a, 11b, 11c is coupled through a connection 14 to an interface unit 12 in the SIM card. Through the interface unit 12 the SIM card can be electrically coupled to the appropriate electrical connections in the terminal. The identification information/codes and code requests, which grant a particular user access to the functions of the terminal, are input to the SIM card through the interface unit 12. In addition, the SIM card stores a record 15 advantageously shared by all users of the terminal. The quantity of user-specific records is limited only the by storage capacity of the SIM card.

FIG. 2 shows by way of example the information advantageously included in a user-specific record 11a, 11b, 11c. Each of the records advantageously includes at least one user-specific PIN code 21. Naturally, there may be several different PIN codes for each individual user. The PIN codes are used to enable various functions for the users in question. It is also advantageous to store at least one Personal Unblocking Code (PUK) 22 for each user. This code is used to prevent the breaking of the PIN code just by trying out different codes, for when a certain number of PIN codes have been tried the SIM card will require this longer code for the purpose of activating the terminal. If the PUK is entered incorrectly for a number of times, the SIM card will lock and the terminal will be rendered useless except for emergency calls. In addition, the SIM card advantageously stores other user-specific passwords 23 which the user possibly has to know when activating the cellular terminal.

A SIM card according to the invention used in a cellular TETRA network may advantageously also include an Individual TETRA Subscriber Identification (ITSI) code 24. This information is needed in the communication in the TETRA network to identify the individual users.

Similarly, a SIM card according to the invention advantageously includes an authentication key 25 needed for connecting the user with the cellular network. Furthermore, the SIM card advantageously includes various encryption keys 26 used in the encryption of traffic, which encryption keys are advantageously stored on the SIM card as user-specific data.

A SIM card according to the invention advantageously stores also other user-specific data 27 useful to the operation of the network or the user.

FIG. 3 shows in the form of an exemplary flow diagram how a SIM card according to the invention can be utilized in a terminal of a cellular TETRA network. In the initial situation a SIM card including user-specific records 11a, 11b, 11c of several users is connected to the terminal. In step 31 the terminal is switched on. After that, the user is requested for the PIN code and he must then respond by entering the PIN code known to him, step 32. In step 33 the PIN code given by the user is matched against data stored on the SIM card 10. In step 34 it is decided whether the PIN code given by the user of the terminal is accepted or not. If the PIN code is not accepted, the PIN code is advantageously requested again, returning to step 32. In this loopback from step 34 to step 32 it is possible to include a counter function for the PIN code attempts, not shown in FIG. 3, in which after a predetermined number of attempts a PUK code needs to be given for the procedure to continue.

When the PIN code has been accepted the user may be requested for some additional identifier/password/identification code in step 35. If no additional identifier is required, the procedure moves on to step 39 in which the terminal is ready. If, however, an additional identifier/user-specific password has to be accepted, the procedure moves from step 35 to step 36. In step 36 the user enters the additional identifier/password known to him. In step 37 the additional identifier/password given by the user is matched against the user-specific additional identifier/password 23 in the SIM card's memory. If the additional identifier/password given by the user is acceptable, the procedure moves from step 38 to step 39 in which the terminal is ready. If in step 38 it is found that the additional identifier/password entered does not match the data 27 stored in the memory of the SIM card, the procedure returns to step 36 in which the user is requested to give the correct additional identifier/password again. In this loopback from step 38 to step 36 it is possible to include a counter function for the additional identifier/password attempts, not shown in FIG. 3, in which after a predetermined number of attempts a PUK code needs to be given for the procedure to continue.

In an embodiment according to the invention the user is requested for the PIN code and also for the additional identifier in step 32 prior to the test on the PIN code. In this embodiment, step 37 follows directly after step 34 if the PIN code matching 34 yields an acceptable result. Naturally, the mutual order of the PIN code matching 34 and additional identifier matching 37 can be changed without any effect on the end result of the identification routine.

FIG. 4 shows a simplified block diagram of a terminal 400 according to the invention. The terminal comprises an antenna 401 for receiving and transmitting radiofrequency (RF) signals. A received RF signal is directed by a switch 402 to a RF receiver 411 where the signal is amplified and converted digital. The signal is then detected and demodulated in block 412. Block 413 performs decryption and deinterleaving. Then follows signal processing in block 430. Received data may be stored as such in the memory 404 of the mobile station or, alternatively, the processed packet data are transferred after the signal processing to a possible external device such as a computer. The control unit 403 controls the above-mentioned reception blocks in accordance with a program stored in the unit.

Transmission from the terminal is performed e.g. as follows. Controlled by the control block 403, block 433 performs possible signal processing on the data and block 421 performs interleaving and encryption on the processed signal to be transmitted. Bursts are generated from the encoded data, block 422, which are modulated and amplified into a RF signal to be transmitted, block 423. The RF signal to be transmitted is conducted to the antenna 401 through the switch 402. Also the processing and transmission functions described above are controlled by the control unit 403.

In the terminal depicted in FIG. 4, the component essential from the point of view of the invention is the SIM card 405 inserted in the device. This SIM card stores all the user-specific data as well as the shared information needed in the operation of the terminal. Furthermore, the terminal according to the invention utilizes a display 432 and keyboard 431. All the codes required by the SIM card are input to the terminal advantageously through the said keyboard.

The invention as such does not impose any requirements different from the prior art on the base stations, not shown in FIG. 4, in the cellular TETRA network.

Embodiments according to the invention were described above. The invention is not limited to the embodiments just described. For example, the order of requesting for the PIN codes and other identifiers may be other than the order according to the example used in the description. Likewise, a SIM card according to the invention may advantageously include other data than those included in the exemplary embodiments presented in the description. Furthermore, the invention is not limited to a terminal of a cellular TETRA network which was used as an example. In addition to that, the terminal may be a terminal of a fixed network as well. The inventional idea may be applied in numerous ways within the scope defined by the claims attached hereto.

1. A SIM card to be inserted in a terminal of a communications network which SIM card comprises means for storing data used in the identification of at least two users and means for carrying out user identification using said data.

2. A SIM card according to claim 1 wherein the SIM card further comprises means for storing data used in a shared manner by all users of said terminal.

3. A SIM card according to claim 1 wherein said data required in the identification of a user comprise at least one user-specific identification code.

4. A SIM card according to claim 3 wherein said data required in the identification of a user comprise at least one of the following codes: user-specific PIN code, user-specific PUK code.

5. A SIM card according to claim 3 wherein said data required in the identification of a user further comprise at least one user-specific password.

6. A SIM card according to claim 3 wherein said data required in the identification of a user further comprise at least one user-specific ITSI code.

7. A SIM card according to claim 1 wherein the SIM card further comprises at least one encryption key used in user-specific authentication.

8. A SIM card according to claim 1 wherein the SIM card further comprises user-specific encryption keys used to encrypt the connection.

9. A SIM card according to claim 1 wherein the SIM card further comprises other user-specific data needed in the operation of the terminal.

10. A SIM card according to the preceding claims wherein said SIM card is arranged so as to be used in a terminal of a network used especially by the authorities.

11. A terminal of a cellular network, arranged so as to perform user identification when the terminal is activated, where the means for identifying the user comprises a SIM card adapted so as to identify at least two users entitled to use the terminal on the basis of at least one user-specific identification code.

12. A terminal according to claim 11 wherein the terminal is arranged so as to be used in a network used especially by the authorities.

13. A terminal according to claim 12 wherein the network used especially by the authorities is a cellular TETRA network.

14. A method for identifying an individual user of a terminal in a communications network, where the user of the terminal is identified on the basis of a personal identification code, wherein the user identification is carried out by matching the identification code given by the user against identification codes stored on the SIM card for different users, and if the identification code given by the user of the terminal is among the said identification codes, the activation of the terminal is allowed.

15. A method according to claim 14 wherein said identification code which entitles the user to use the terminal, is a personal PIN code.

16. A method according to claim 14 wherein the method further comprises a step in which the user of the terminal is requested for a second additional identifier/password for activating the terminal.

17. A method according to claims 14 to 16 wherein if the person trying to activate the terminal enters more than a predetermined number of times a wrong code as a response to the said code requests, the user must enter a personal PUK code before user identification can be continued.
